(19) United States
(12) Patent Application Publication
(10) Pub. No.: US 2026/0212448 A1
(43) Pub. Date: Jul. 23, 2026

(54) STEREOSCOPIC IMAGE DISPLAY SYSTEM AND STEREOSCOPIC IMAGE GENERATION METHOD FOR PANORAMIC IMAGE

(71) Applicant: Acer Incorporated, New Taipei City (TW)

(72) Inventors: Sergio Cantero Clares, New Taipei City (TW); Shih-Hao Lin, New Taipei City (TW)

(73) Assignee: Acer Incorporated, New Taipei City (TW)

(21) Appl. No.: 19/034,583

(22) Filed: Jan. 23, 2025

(51) Int. Cl. G06T 3/4038; G06T 7/10; G06T 7/50; G06T 17/20

(52) U.S. Cl. CPC G06T 3/4038; G06T 7/10; G06T 7/50; G06T 17/20; G06T 2207/20132

(57) ABSTRACT

A stereoscopic image generation method for panoramic image and a stereoscopic image display system are disclosed. The method comprises the following steps. A partial view frame is cropped from a panoramic image. An initial 3D mesh in spherical coordinate system is established for the partial view frame. Depth estimation is performed on the partial view frame to obtain a target depth map. The initial 3D mesh of the partial view frame is updated based on the target depth map to generate a three-dimensional scene mesh. A side-by-side image, including a left-eye view and a right-eye view, is generated through performing camera projection processing according to the three-dimensional scene mesh.

### BACKGROUND

### Technical Field

The disclosure relates to an image processing technique, and particularly to a stereoscopic image display system and a stereoscopic image generation method for panoramic image.

### Description of Related Art

With the advancement of display technology, stereoscopic displays supporting stereoscopic vision technology have gradually become widespread. Stereoscopic vision technology allows viewers to perceive a sense of three-dimensionality in image scenes, such as three-dimensional facial features and depth of field, which traditional 2D images cannot present. The principle of stereoscopic vision technology is to let the viewer's left eye view the left eye image and the right eye view the right eye image, allowing the viewer to experience a 3D visual effect. Stereoscopic displays can provide left eye images and right eye images separately to the viewer's left and right eyes, offering people a visually immersive experience. However, the current market lacks sufficient 3D image content, so even if users have a stereoscopic display, they still cannot fully and freely enjoy the display effects brought by the stereoscopic display. At present, although there are techniques for generating stereoscopic content from monocular image content, they are not applicable to panoramic images.

### SUMMARY

The disclosure provides a stereoscopic image display system and a stereoscopic image generation method for panoramic image that can effectively solve the aforementioned problems.

An exemplary embodiment of the disclosure provides a stereoscopic image generation method for panoramic image, which is applicable to a stereoscopic image display system including a stereoscopic display and includes the following steps. A partial view frame is cropped from a panoramic image. An initial three-dimensional mesh in a spherical coordinate system is established for the partial view frame. Depth estimation is performed on the partial view frame to obtain a target depth map. The initial three-dimensional mesh of the partial view frame is updated according to the target depth map to obtain a three-dimensional scene mesh. A side-by-side image including a left eye image and a right eye image is generated by performing camera projection processing based on the three-dimensional scene mesh.

Another exemplary embodiment of the disclosure provides a stereoscopic image display system, which includes a stereoscopic display and at least one processor. The processor is coupled to the stereoscopic display and configured to perform the following operations. A partial view frame is cropped from a panoramic image. An initial three-dimensional mesh in a spherical coordinate system is established for the partial view frame. Depth estimation is performed on the partial view frame to obtain a target depth map. The initial three-dimensional mesh of the partial view frame is updated according to the target depth map to obtain a three-dimensional scene mesh. A side-by-side image including a left eye image and a right eye image is generated by performing camera projection processing based on the three-dimensional scene mesh.

Based on the above, in the embodiments of the disclosure, a partial view frame may be cropped from a panoramic image, and an initial three-dimensional mesh of the partial view frame may be established in a spherical coordinate system. After performing depth estimation on the partial view frame, the spherical coordinate of each mesh vertex in the initial three-dimensional mesh may be updated according to the target depth map to obtain the three-dimensional scene mesh. Then, camera projection processing may be performed based on the three-dimensional scene mesh to generate a side-by-side image including content with different viewing angles. Accordingly, the three-dimensional scene mesh can accurately present the depth variations in the scene, providing a more realistic three-dimensional visual experience.

### BRIEF DESCRIPTION OF THE DRAWINGS

FIG. 1 is a schematic diagram of a stereoscopic image display system according to an embodiment of the disclosure.

FIG. 2 is a schematic diagram of a stereoscopic display according to an embodiment of the disclosure.

FIG. 3 is a flowchart of a stereoscopic image generation method for panoramic image according to an embodiment of the disclosure.

FIG. 4 is a schematic diagram of a panoramic image and an initial three-dimensional mesh according to an embodiment of the disclosure.

FIG. 5 is a flowchart of generating an initial three-dimensional mesh according to an embodiment of the disclosure.

FIG. 6 is a schematic diagram of generating spherical coordinate of each mesh vertex in a three-dimensional scene mesh according to an embodiment of the disclosure.

FIG. 7 is a flowchart of a stereoscopic image generation method for panoramic image according to an embodiment of the disclosure.

FIG. 8 is a flowchart of a stereoscopic image generation method for panoramic image according to an embodiment of the disclosure.

FIG. 9 is a flowchart of obtaining a target depth map according to an embodiment of the disclosure.

### DESCRIPTION OF THE EMBODIMENTS

Some of the exemplary embodiments of the disclosure will be described in detail with the accompanying drawings. The reference numerals used in the following description will be regarded as the same or similar components when the same reference numerals appear in different drawings. These exemplary embodiments are only a part of the disclosure, and do not disclose all of the ways in which the disclosure can be implemented. More specifically, these exemplary embodiments are only examples of the method and the system in the claims of the disclosure.

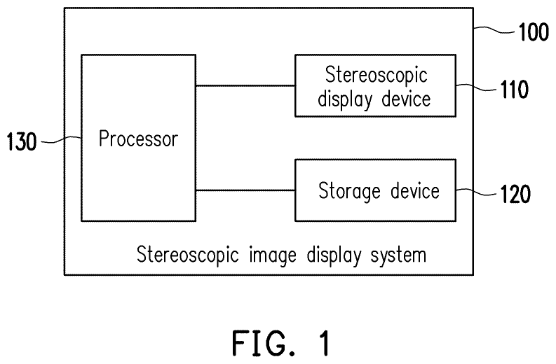

FIG. 1 is a schematic diagram of a stereoscopic image display system according to an embodiment of the disclosure. Referring to FIG. 1, the stereoscopic image display system 100 may include a stereoscopic display 110, a storage device 120, and at least one processor 130. In various embodiments, the stereoscopic image display system 100 may be implemented as an integrated system or a separate system. In some embodiments, the stereoscopic display 110, the storage device 120, and the processor 130 may be implemented in an all-in-one electronic device, such as a laptop computer, a tablet computer, a desktop computer, a game console, a portable electronic device, or other personal electronic devices. Alternatively, in some embodiments, the stereoscopic display 110 may be connected to a computing device including the storage device 120 and the processor 130 through a wired or wireless transmission interface.

The stereoscopic display 110 may allow users to perceive stereoscopic visual effects. In order for users to perceive 3D visual effects through the stereoscopic display 110, the stereoscopic display 110 may, according to its hardware specifications and the stereoscopic display technique applied, allow the user's left eye and right eye to view image content corresponding to different viewing angles (i.e., left eye image and right eye image) respectively.

In some embodiments, the stereoscopic display 110 may be a glasses-free stereoscopic display, for example, it may be implemented as a display for a laptop computer, a television, a desktop monitor, or an electronic signage, etc. In some embodiments, the left eye image and right eye image may be displayed simultaneously based on stereoscopic display techniques, such as parallax barrier technique, lens technique, or directional backlight technique. Alternatively, in some embodiments, the stereoscopic display 110 may be a head-mounted display device, for example, it may be implemented as a virtual reality display device or a mixed reality display device, etc.

From another perspective, the stereoscopic display 110 may include a Liquid Crystal Display (LCD), a Light-Emitting Diode (LED) display, an Organic Light-Emitting Diode (OLED) display, or other types of displays. The disclosure is not limited in this regard.

The storage device 120 is configured to temporarily or permanently store data, such as images, instructions, code, software modules, etc. Specifically, the storage device 120 may include volatile storage circuits. Volatile storage circuits are used to store data in a volatile manner. For example, volatile storage circuits may include random access memory (RAM) or similar volatile storage media. Alternatively, the storage device 120 may include non-volatile storage circuits. Non-volatile storage circuits are used to store data in a non-volatile manner. For example, non-volatile storage circuits may include read-only memory (ROM), solid-state drive (SSD), and/or traditional hard disk drive (HDD) or similar non-volatile storage media. The number of storage devices 120 may be one or more, and the disclosure does not impose any limitations in this regard.

The processor 130 is connected to the stereoscopic display 110 and the storage device 120. For example, the processor 130 may include a central processing unit (CPU), a graphic processing unit (GPU), or other programmable general-purpose or special-purpose microprocessors, digital signal processors (DSP), programmable controllers, application-specific integrated circuits (ASIC), programmable logic devices (PLD), or other similar devices or combinations of these devices. The number of processors 130 may be one or more, and the disclosure does not impose any limitations in this regard.

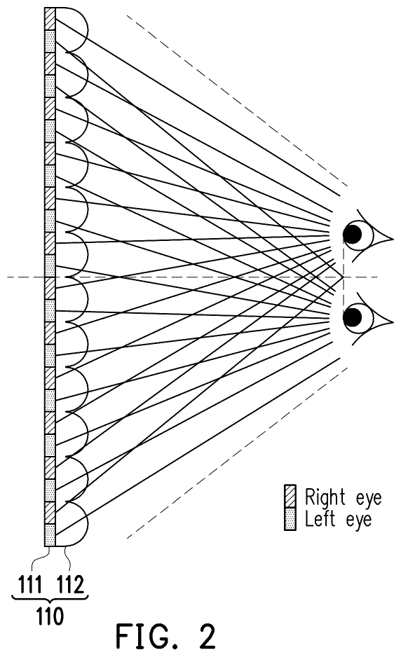

FIG. 2 is a schematic diagram of a stereoscopic display according to an embodiment of the disclosure. Referring to FIG. 2, in some embodiments, the stereoscopic display 110 may be a naked-eye stereoscopic display, which may provide different images for the left eye and right eye through lens refraction principles, allowing viewers to experience a stereoscopic display effect. The stereoscopic display 110 may include a display panel 111 and a lens layer 112. The lens layer 112 is placed above the display panel 111, and viewers can see the content provided by the display panel 111 through the lens layer 112. The stereoscopic display 110 can place the pixels of the first left eye image and the first right eye image at corresponding pixel positions on the display panel 111. The lens layer 112, through light refraction, refracts different display content (i.e., left eye image and right eye image) to different positions in space, allowing the left eye and right eye to receive two different images with parallax. It is known that in order to place the pixels of the left eye image and the right eye image at the corresponding pixel positions on the display panel 111, the left eye image and right eye image need to undergo image interweaving processing to generate an interwoven frame with alternating pixels from the left eye image and the right eye image.

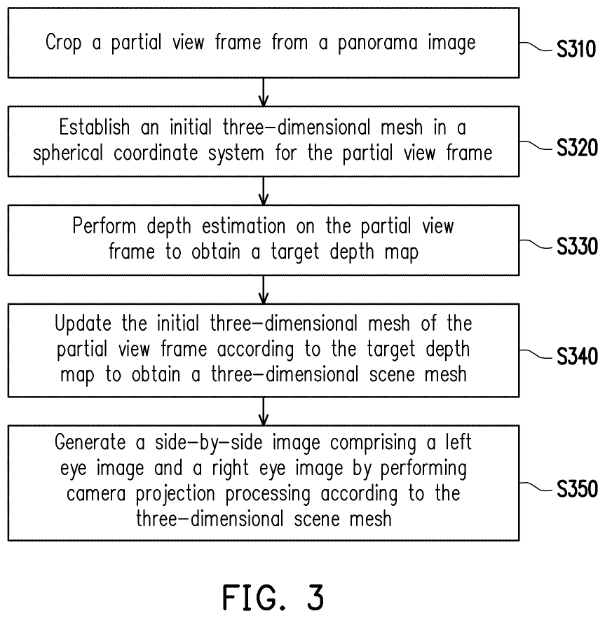

FIG. 3 is a flowchart of a stereoscopic image generation method according to an embodiment of the disclosure. Referring to FIG. 3, the operation process of this embodiment is applicable to the stereoscopic image display system 100 in the above-mentioned embodiment. The following will explain the detailed steps of this embodiment in conjunction with the various components in the stereoscopic image display system 100.

At step S310, the processor 130 may crop a partial view frame from a panorama image. The processor 130 may obtain a panorama image. A panorama image is a form of image that can display a full field of view range, typically covering a complete spherical or cylindrical range in a 360-degree manner, allowing viewers to view the scene in the image from any angle. For example, the panorama image may capture a complete scene with 360 degrees in the horizontal direction and 180 or 360 degrees in the vertical direction.

In some embodiments, the panorama image may convert the captured spherical or cylindrical viewing angle data into a planar image for storage, processing, and display. In other words, the spherical or cylindrical scene of the panorama image can be projected to unfold the spherical or cylindrical scene of the panorama image into a planar image. The aforementioned projection may include Equirectangular Projection or Fisheye Projection, among others.

In some embodiments, the processor 130 may crop a partial view frame corresponding to a specific field of view (FOV) from the panorama image. In some embodiments, the processor 130 may determine a field of view. Subsequently, the processor 130 may crop the partial view frame from the panorama image according to the field of view.

Specifically, the processor 130 may dynamically calculate the cropping range and the central point position of the partial view frame based on the data format of the panoramic image (e.g., equirectangular projection or other spherical projection methods) and the field of view parameters. The processor 130 may determine the field of view of the cropping area within the panoramic image based on the input FOV parameters, including gaze azimuth, horizontal viewing angle range, gaze elevation angle, and vertical viewing angle range. In some embodiments, the processor 130 may calculate the corresponding pixel coordinate of the central point of the cropping range (i.e., the partial view frame) within the panoramic image based on the field of view and the user's viewing direction (i.e., gaze azimuth and gaze elevation angle).

In some embodiments, the field of view used to crop the partial view frame may be determined based on user input, an application setting, or metadata of the panorama image. The aforementioned user input may be dynamic input or fixed values. In other words, the field of view used to crop the partial view frame may be fixed data or real-time dynamic data. For example, the aforementioned user input may be cursor input controlling the viewing angle, and so on.

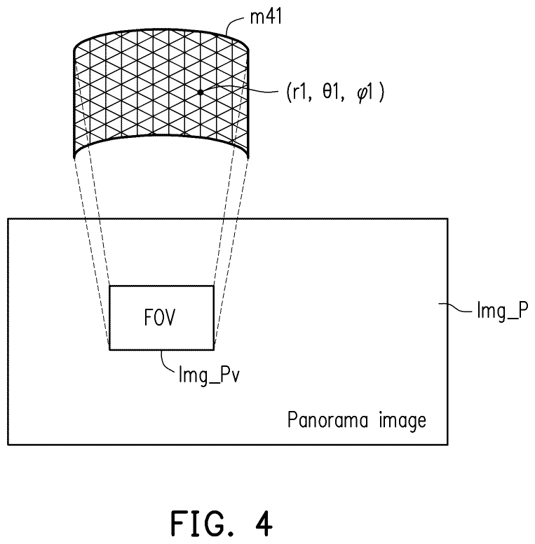

For example, referring to FIG. 4, which is a schematic diagram of a panorama image and an initial three-dimensional mesh according to an embodiment of the disclosure. The processor 130 may crop a partial view frame Img_Pv from the panorama image Img_P according to the field of view FOV. However, FIG. 4 illustrates an example where the panorama image Img_P is projected as a planar image, but it is not limited to this. In some other embodiments, the processor 130 may first project the panorama image Img_P as a spherical scene, and crop the partial view frame from the spherical scene according to the field of view.

At step S320, the processor 130 may establish an initial three-dimensional mesh in a spherical coordinate system for the partial view frame. The three-dimensional scene mesh is a fundamental structure for rendering three-dimensional scenes and objects, and the three-dimensional scene mesh may be composed of polygons (e.g., triangles or quadrilaterals). In some embodiments, the processor 130 may initialize an initial three-dimensional mesh. The depth values (i.e., Z-axis coordinate) of each mesh vertices in the initial three-dimensional mesh may be preset to a fixed value. In various embodiments, the X-axis coordinate and Y-axis coordinate of multiple mesh vertices in the initial three-dimensional mesh may be determined based on regular distribution, random distribution, or specific distribution based on image content (e.g., texture or contours, etc.).

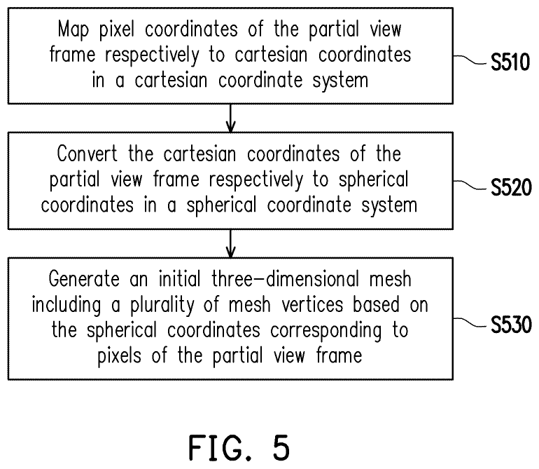

Referring to FIG. 5, which is a flowchart of generating an initial three-dimensional mesh according to an embodiment of the disclosure. In some embodiments, step S320 may be implemented as steps S510 to S530. At step S510, the processor 130 maps pixel coordinates of the partial view frame to cartesian coordinates in a cartesian coordinate system, respectively. The aforementioned multiple pixel coordinates may be mesh vertices on the XY plane determined based on regular distribution, random distribution, or specific distribution based on image content (e.g., texture or contours, etc.). Each cartesian coordinate includes an X-axis coordinate, a Y-axis coordinate, and a Z-axis coordinate.

In some embodiments, the multiple pixel coordinates of the partial view frame are mapped to multiple cartesian coordinates based on a preset reference depth. The aforementioned preset reference depth is, for example, a preset focal length of a virtual camera. In other words, the Z-axis coordinates of the multiple cartesian coordinates are all the same and may be equal to the preset focal length.

At step S520, the processor 130 may convert the multiple cartesian coordinates of the partial view frame to the spherical coordinates in a spherical coordinate system, respectively. For example, the processor 130 may convert the cartesian coordinate (x, y, z) of the partial view frame to a spherical coordinate (r, θ, φ) in the spherical coordinate system according to the following formulas (1) to (3).

$$r = \sqrt{{x}^{2} + {y}^{2} + {z}^{2}} \qquad Formula ( 1 )$$

$$θ = arc cos \frac{z}{\sqrt{{x}^{2} + {y}^{2} + {z}^{2}}} = arc cos \frac{z}{r} = \{ \begin{matrix}arc tan \frac{\sqrt{{x}^{2} + {y}^{2}}}{z} & if z > 0 \\ π + arc tan \frac{\sqrt{{x}^{2} + {y}^{2}}}{z} & if z < 0 \\ + \frac{π}{2} & if z = 0 and \sqrt{{x}^{2} + {y}^{2}} \neq 0 \\ undefined & if x = y = z = 0\end{matrix} \qquad Formula ( 2 )$$

$$φ = sgn ( y ) arc cos \frac{x}{\sqrt{{x}^{2} + {y}^{2}}} = \{ \begin{matrix}arc tan ( \frac{y}{x} ) & if x > 0 , \\ arc tan ( \frac{y}{x} ) + π & if x < 0 and y \geq 0 , \\ arc tan ( \frac{y}{x} ) - π & if x < 0 and y < 0 , \\ + \frac{π}{2} & if x = 0 and y > 0 , \\ - \frac{π}{2} & if x = 0 and y < 0 \\ undefined & if x = 0 and y = 0.\end{matrix} \qquad Formula ( 3 )$$

Wherein r represents the radial component; θ represents the azimuthal angle; φ represents the polar angle.

At step S530, the processor 130 may generate an initial three-dimensional mesh including multiple mesh vertices based on the multiple spherical coordinates corresponding to the pixels of the partial view frame. Specifically, the processor 130 may convert the cartesian coordinates of the mesh vertices in the partial view frame to multiple spherical coordinates in the spherical coordinate system, respectively. Subsequently, according to these spherical coordinates of the mesh vertices, the processor 130 may obtain an initial three-dimensional mesh in the spherical coordinate system.

For example, referring to FIG. 4 again, which is a schematic diagram of a panorama image and an initial three-dimensional mesh according to an embodiment of the disclosure. The processor 130 may establish an initial three-dimensional mesh m41 in the spherical coordinate system for the partial view frame Img_Pv. The spherical coordinate of a certain mesh vertex of the initial three-dimensional mesh m41 may be (r1, θ1, φ1).

Returning to FIG. 3, at step S330, the processor 130 may perform depth estimation on the partial view frame to obtain a target depth map. In some embodiments, the processor 130 may perform depth estimation on the partial view frame in planar image form. In some embodiments, the processor 130 may execute a monocular depth estimation on the partial view frame in planar image form to obtain the target depth map of the partial view frame. By executing the monocular depth estimation, the processor 130 may estimate the depth information of the partial view frame based on the partial view frame from a single viewing angle. The depth information of the partial view frame may include a depth map or point cloud, etc.

It should be noted that, since the partial view frame is a portion of the field of view of the panorama image, inputting the partial view frame into the monocular depth estimation model can obtain more accurate depth estimation results compared to directly inputting the complete panorama image into the monocular depth estimation model. The reason is that the monocular depth estimation model is usually trained based on ordinary planar images (such as perspective projection), rather than specifically designed for panorama image. In comparison, the partial view frame can be closer to the model's training data, reducing depth estimation errors due to image geometric distortion.

In some embodiments, the processor 130 may use a deep learning model to execute monocular depth estimation on the partial view frame. The processor 130 may input the partial view frame into a trained monocular depth estimation model to obtain a depth map of the partial view frame. Alternatively, in some embodiments, the processor 130 may use other conventional vision algorithms to execute monocular depth estimation on the partial view frame. For example, the processor 130 may analyze disparity information in the partial view frame, image features at different scales, or motion trajectories of objects, etc., to estimate the depth information of the partial view frame. It should be noted that in some embodiments, the depth values in the depth information obtained through monocular depth estimation have already been normalized to be within a preset numerical range. For example, the depth values in the target depth map may range from 0 to 255.

At step S340, the processor 130 may update the initial three-dimensional mesh of the partial view frame according to the target depth map to obtain a three-dimensional scene mesh. In some embodiments, the radial component of each mesh vertex of the three-dimensional scene mesh in the spherical coordinate system may be determined based on the corresponding depth value in the target depth map. In other words, the processor 130 may generate the three-dimensional scene mesh by adjusting the radial component of each mesh vertex in the initial three-dimensional mesh according to the target depth map.

In some embodiments, the processor 130 may adjust the radial component of the first spherical coordinate of each mesh vertex in the initial three-dimensional mesh using the target depth map to obtain the second spherical coordinate of each mesh vertex in the three-dimensional scene mesh. Specifically, based on the depth value corresponding to a certain mesh vertex in the target depth map, the processor 130 may adjust the radial component of the first spherical coordinate of that mesh vertex in the initial three-dimensional mesh. The radial component of the first spherical coordinate of each mesh vertex in the initial three-dimensional mesh are the same, but the radial component of the second spherical coordinate of each mesh vertex in the three-dimensional scene mesh are determined based on the corresponding depth values.

In some embodiments, the radial component of the second spherical coordinate of a first mesh vertex in the three-dimensional scene mesh may be the radial component of the first spherical coordinate of the first mesh vertex in the initial three-dimensional mesh plus a corresponding depth value in the target depth map. The first mesh vertex may be any one of mesh vertices. For example, assuming that the radial component of the first spherical coordinate of a certain mesh vertex is “ra” and the corresponding depth value is “Δd”, then the radial component of the second spherical coordinate of the mesh vertex is “ra+Δd”. It can be known that the radial components of the second spherical coordinate of all mesh vertices in the three-dimensional scene mesh may fall within a specific radial range.

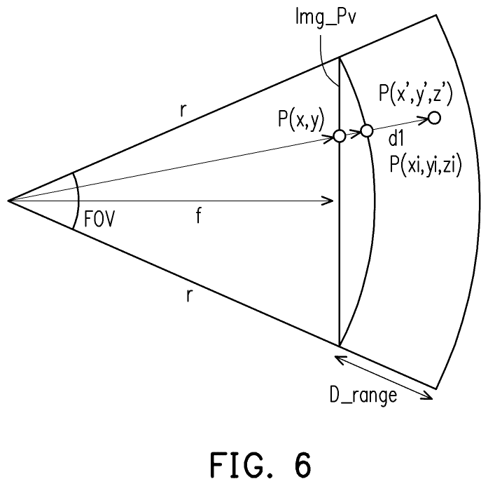

For example, referring to FIG. 6, which is a schematic diagram illustrating the generation of spherical coordinate for each mesh vertex in the three-dimensional scene mesh according to an embodiment of the disclosure. The processor 130 may map the pixel coordinate P(x,y) of a certain mesh vertex in the partial view frame Img_Pv to a cartesian coordinate P(xi, yi, zi) given a fixed depth. As shown in FIG. 6, the aforementioned fixed depth may be equal to the focal length “f”. The processor 130 may project the cartesian coordinate P(xi, yi, zi) to the first spherical coordinate in the spherical coordinate system, and then use the depth corresponding to the pixel coordinate P(x,y) in the target depth map to adjust the radial component of the first spherical coordinate to obtain the second spherical coordinate. Subsequently, the processor 130 may map the second spherical coordinate back to cartesian coordinates P(x′, y′, z′). Based on similar processing, the pixel coordinate of each mesh vertex in the partial view frame Img_Pv may be mapped to cartesian coordinates determined based on depth information, and the radial components of the spherical coordinates of multiple mesh vertices in the partial view frame Img_Pv fall within the depth range D_range. In some embodiments, the processor 130 may map the second spherical coordinate (r′, θ, φ) back to cartesian coordinates P(x′, y′, z′) according to the following formulas (4) to (6).

$${x}^{′} = {r}^{′} sin θ cos φ \qquad formula ( 4 )$$

$${y}^{′} = {r}^{′} sin θ sin φ \qquad formula ( 5 )$$

$${z}^{′} = {r}^{′} cos θ \qquad formula ( 6 )$$

At step S350, the processor 130 may generate a side-by-side image including a left eye image and a right eye image by performing camera projection processing based on the three-dimensional scene mesh. In this embodiment, the camera projection processing is a forward projection based on the Pinhole Camera Model, which may project the cartesian coordinates in the three-dimensional scene mesh onto the left eye pixel plane and the right eye pixel plane respectively. The processor 130 may use the intrinsic and extrinsic parameters of the left virtual camera to project the three-dimensional scene mesh and generate the left eye image. The processor 130 may use the intrinsic and extrinsic parameters of the right virtual camera to project the three-dimensional scene mesh and generate the right eye image.

In some embodiments, based on the camera projection parameters, the processor 130 may project the spherical coordinate of each of the multiple mesh vertices of the three-dimensional scene mesh onto the left eye pixel plane and the right eye pixel plane to generate the left eye image and the right eye image. Subsequently, the processor 130 may combine the left eye image and the right eye image according to a side-by-side format to obtain the side-by-side image. Based on the aforementioned, the processor 130 may convert the second spherical coordinate of each mesh vertex of the three-dimensional scene mesh of the partial view frame into optimized cartesian coordinates in the rectangular coordinate system. Afterwards, the processor 130 may project the optimized cartesian coordinate of each of the multiple mesh vertices of the three-dimensional scene mesh onto the left eye pixel plane and the right eye pixel plane respectively, based on the camera projection parameters.

Specifically, the processor 130 may generate the left eye image by projecting the spherical coordinates of each of the multiple mesh vertices onto a two-dimensional image coordinate system according to the pinhole camera model of the left virtual camera corresponding to the left eye viewing angle. In other words, the processor 130 may convert the spherical coordinate of each of the multiple mesh vertices into a two-dimensional image coordinate system to obtain the left eye image, based on the extrinsic parameter matrix and intrinsic parameter matrix of the left virtual camera corresponding to the left eye. Similarly, the processor 130 may project the spherical coordinate of each of the multiple mesh vertices onto a two-dimensional image coordinate system to obtain the right eye image, based on the extrinsic parameter matrix and intrinsic parameter matrix of the right virtual camera corresponding to the right eye. Thus, by stitching the left eye image and the right eye image, the processor 130 may generate a side-by-side image. The camera intrinsic parameters may be a camera intrinsic parameter matrix, and include focal length information in the x-axis and γ-axis directions on the image plane and the position of the principle point.

Subsequently, the processor 130 may utilize a stereoscopic display 110 to perform stereoscopic display operations according to the side-by-side image. In some embodiments, the processor 130 may control the stereoscopic display 110 to operate in a stereoscopic display mode to display the side-by-side image including the left eye image and the right eye image. Specifically, when the stereoscopic display 110 is an autostereoscopic display, the processor 130 may perform image interleaving processing on the side-by-side image to obtain an interlaced image, where this image interleaving processing arranges the pixels of the left eye image and the pixels of the right eye image from the side-by-side image alternately in the interlaced frame. Afterwards, when the stereoscopic display 110 operates in the stereoscopic display mode, the display panel 111 of the stereoscopic display 110 will display the interlaced image, and the refraction function of the lens layer 112 of the stereoscopic display 110 is enabled, allowing the viewer to perceive a stereoscopic visual effect.

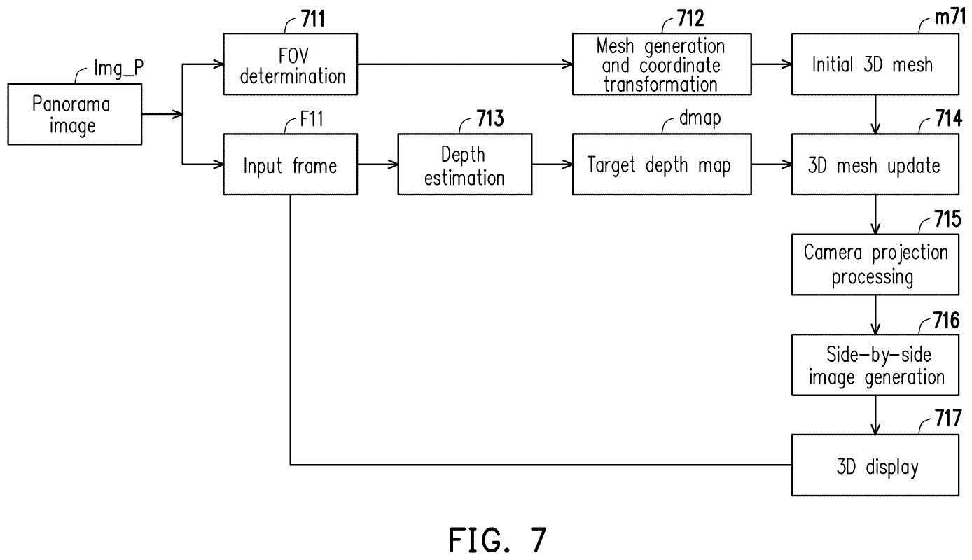

FIG. 7 is a flowchart of a stereoscopic image generation method for panoramic images according to embodiments of the present disclosure. Referring to FIG. 7, at step 711, the processor 130 may determine the field of view. At step 712, the processor 130 may initialize the mesh and convert it to a spherical coordinate system to generate an initial three-dimensional mesh m71. On the other hand, the processor 130 may generate an input frame F11 by cropping a partial view frame from the panoramic image Img_P according to the field of view. At step 713, by performing depth estimation on the input frame F11, the processor 130 may generate a target depth map dmap of the input frame F11.

Subsequently, at step 714, the processor 130 may update the radial component corresponding to each mesh vertex using the normalized depth values in the target depth map dmap. The initial three-dimensional mesh m71 may be updated to generate a three-dimensional scene mesh of the partial view frame. At step 715, the processor 130 may project the cartesian coordinates corresponding to each mesh vertex in the three-dimensional scene mesh onto the pixel plane according to the projection parameters of the camera projection processing, to generate the left eye image and the right eye image. Thus, at step 716, the processor 130 may generate a side-by-side image based on the left eye image and the right eye image. Finally, at step 717, the processor 130 may perform stereoscopic display through the stereoscopic display 110 according to the side-by-side image.

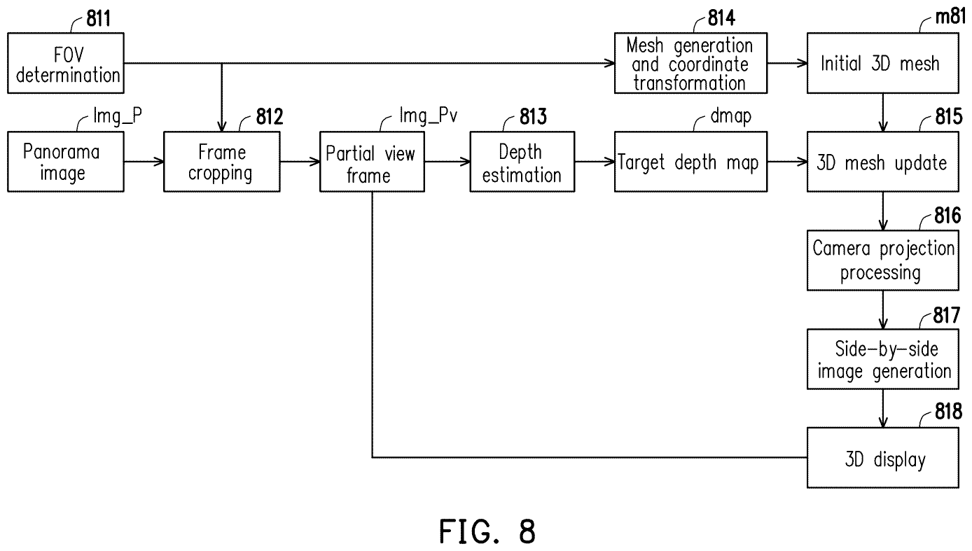

FIG. 8 is a flowchart of a stereoscopic image generation method for panoramic images according to embodiments of the present disclosure. Referring to FIG. 8, at step 811, the processor 130 may dynamically determine the field of view according to user operations. At step 812, the processor 130 may crop a partial view frame Img_Pv from the panoramic image Img_P according to the field of view. From this, it can be understood that when the field of view changes dynamically, the virtual viewing angles corresponding to the left eye and right eye may be considered as rotating around the center of the spherical coordinate system.

At step 813, by performing depth estimation on the partial view frame Img_Pv, the processor 130 may generate a target depth map dmap of the partial view frame Img_Pv. At step 814, the processor 130 may initialize the mesh and convert it to a spherical coordinate system to generate an initial 3D mesh m81. Subsequently, at step 815, the processor 130 may update the radial component corresponding to each mesh vertex in the initial 3D mesh m81 using the normalized depth values in the target depth map dmap. The initial 3D mesh m81 may be updated to generate a three-dimensional scene mesh of the partial view frame. At step 816, the processor 130 may project the cartesian coordinate corresponding to each mesh vertex in the three-dimensional scene mesh onto the pixel plane according to the projection parameters of the camera projection processing, to generate the left eye image and the right eye image. Thus, at step 817, the processor 130 may generate a side-by-side image based on the left eye image and the right eye image. Finally, at step 818, the processor 130 may perform stereoscopic display through the stereoscopic display 110 according to the side-by-side image.

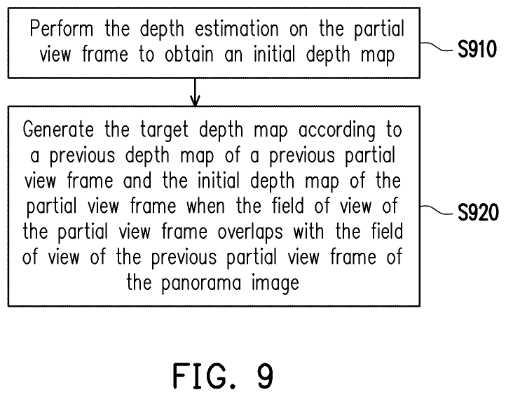

FIG. 9 is a flowchart of obtaining a target depth map according to embodiments of the present disclosure. Referring to FIG. 9, at step S910, the processor 130 may perform depth estimation on the partial view frame to obtain an initial depth map. At step S920, when the field of view of the partial view frame overlaps with the field of view of a previous partial view frame of the panoramic image, the processor 130 may generate the target depth map based on the previous depth map of the previous partial view frame and the initial depth map of the partial view frame. Specifically, as the field of view changes dynamically, the field of view of the current partial view frame may overlap with the field of view of the previous partial view frame. To improve the accuracy of depth estimation, the processor 130 may perform averaging operations on the depth values within the overlapping range of the field of view to obtain the target depth map of the current partial view frame.

For example, assuming the azimuth angle of the field of view of the previous partial view frame is 0 to 60 degrees, and the azimuth angle of the field of view of the current partial view frame is 30 to 90 degrees. The processor 130 may estimate a first depth map of the previous partial view frame and a second depth map of the current partial view frame, respectively. The first depth map includes multiple first depth values. The second depth map includes multiple second depth values. Then, the processor 130 may perform averaging operations on the first depth values and the second depth values of each mesh vertex with azimuth angles between 30 degrees and 60 degrees to determine the depth values of each mesh vertex with azimuth angles between 30 degrees and 60 degrees in the target depth map.

In summary, in the embodiments of the disclosure, a partial view frame may be cropped from the panoramic image, and an initial three-dimensional mesh of the partial view frame in the spherical coordinate system may be created. After performing depth estimation on the partial view frame, the spherical coordinate of each mesh vertex in the initial three-dimensional mesh may be updated according to the target depth map to obtain the three-dimensional scene mesh. Thus, camera projection processing may be performed based on the three-dimensional scene mesh to generate side-by-side images including content from different viewing angles. Based on this, the three-dimensional scene mesh in the spherical coordinate system can accurately present the depth changes in the spherical scene, providing a more realistic three-dimensional visual experience. Furthermore, by estimating the depth for the angle of interest (such as the cropped field of view range), the computational load is reduced and the accuracy of the stereoscopic effect is improved.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A stereoscopic image generation method for panorama image, comprising:
cropping a partial view frame from a panorama image;
establishing an initial three-dimensional mesh in a spherical coordinate system for the partial view frame;
performing depth estimation on the partial view frame to obtain a target depth map;
updating the initial three-dimensional mesh of the partial view frame according to the target depth map to obtain a three-dimensional scene mesh; and
generating a side-by-side image comprising a left eye image and a right eye image by performing camera projection processing according to the three-dimensional scene mesh.

2. The stereoscopic image generation method for panorama image as claimed in claim 1, wherein the step of cropping the partial view frame from the panorama image comprises:
determining a field of view (FOV); and
cropping the partial view frame from the panorama image according to the field of view.

3. The stereoscopic image generation method for panorama image as claimed in claim 2, wherein the field of view is determined based on user input, an application setting, or metadata of the panorama image.

4. The stereoscopic image generation method for panorama image as claimed in claim 1, wherein the step of establishing the initial three-dimensional mesh in the spherical coordinate system for the partial view frame comprises:
mapping a plurality of pixel coordinates of the partial view frame to a plurality of cartesian coordinates in a cartesian coordinate system;
converting the plurality of cartesian coordinates of the partial view frame to a plurality of spherical coordinates in the spherical coordinate system; and
generating the initial three-dimensional mesh comprising a plurality of mesh vertices based on the plurality of spherical coordinates corresponding to the plurality of pixels of the partial view frame.

5. The stereoscopic image generation method for panorama image as claimed in claim 4, wherein the plurality of pixel coordinates of the partial view frame are mapped to the plurality of cartesian coordinates based on a preset reference depth.

6. The stereoscopic image generation method for panorama image as claimed in claim 1, wherein the step of updating the initial three-dimensional mesh of the partial view frame according to the target depth map to obtain the three-dimensional scene mesh comprises:
adjusting radial component of a first spherical coordinate of each of the mesh vertices in the initial three-dimensional mesh using the target depth map to obtain a second spherical coordinate of each of the plurality of mesh vertices in the three-dimensional scene mesh.

7. The stereoscopic image generation method for panorama image as claimed in claim 6, wherein the radial component of the second spherical coordinate of the first mesh vertex in the three-dimensional scene mesh is determined by adding the radial component of the first spherical coordinate of the first mesh vertex in the initial 3D mesh to a corresponding depth value from the target depth map.

8. The stereoscopic image generation method for panorama image as claimed in claim 1, wherein the step of generating the side-by-side image comprising the left eye image and the right eye image by performing the camera projection processing on the three-dimensional scene mesh comprises:
projecting the spherical coordinate of each of the plurality of mesh vertices of the three-dimensional scene mesh onto a left eye pixel plane and a right eye pixel plane based on camera projection parameters to generate the left eye image and the right eye image; and
combining the left eye image and the right eye image in a side-by-side format to obtain the side-by-side image.

9. The stereoscopic image generation method for panorama image as claimed in claim 1, wherein the step of performing the depth estimation on the partial view frame to obtain the target depth map comprises:
performing the depth estimation on the partial view frame to obtain an initial depth map; and
generating the target depth map according to a previous depth map of a previous partial view frame and the initial depth map of the partial view frame when the field of view of the partial view frame overlaps with the field of view of the previous partial view frame of the panorama image.

10. The stereoscopic image generation method for panorama image as claimed in claim 1, further comprising:
performing a stereoscopic display operation using a stereoscopic display device according to the side-by-side image.

11. A stereoscopic image display system, comprising:
a stereoscopic display device; and
at least one processor, coupled to the stereoscopic display device, and configured to:
crop a partial view frame from a panorama image;
establish an initial three-dimensional mesh in a spherical coordinate system for the partial view frame;
perform depth estimation on the partial view frame to obtain a target depth map;
update the initial three-dimensional mesh of the partial view frame according to the target depth map to obtain a three-dimensional scene mesh; and
generate a side-by-side image comprising a left eye image and a right eye image by performing camera projection processing according to the three-dimensional scene mesh.
